(19) United States
(12) Patent Application Publication
(10) Pub. No.: US 2005/0101502 A1
(43) Pub. Date: May 12, 2005

(54) Pretreating and dispensing system

(75) Inventors: Howard Anthony Barnes, Merseyside (GB); John Hines, Merseyside (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 10/643,228

(22) Filed: Aug. 18, 2003

(30) Foreign Application Priority Data
Aug. 20, 2002 (EP) 02255788.8

(51) Int. Cl. C11D 17/00

(52) U.S. Cl. 510/296; 510/439

(57) ABSTRACT

The present invention provides a dosing and dispensing system, comprising a liquid detergent composition and a dosing and dispensing device, wherein the liquid detergent composition is a non-Newtonian fluid having zero-shear viscosity of at least 10,000 mPa·s and a viscosity under a shear field of 10 s⁻¹ of at most 5000 mPa·s. The device comprises a hollow body containing the liquid detergent composition and dispensing means comprising a freely rotatable ball for spreading at least a portion of the liquid detergent composition onto fabrics. This system which is suitable for both pretreatment of fabrics and use in the main wash, allows for a simple, safe and leak-free operation.

### FIELD OF THE INVENTION

The present invention relates to a dosing and dispensing system for liquid laundry detergents. The device according to the present invention is particularly suitable for pretreating fabrics with a portion of the liquid detergent contained therein.

### BACKGROUND OF THE INVENTION

Dispensing devices for liquid laundry detergent which are designed to be introduced with the fabric to be cleaned into the washing machine, are well-known in the art.

It is also well known to pretreat stained areas of fabric with liquid laundry detergent, before the main wash.

In these known pretreatment methods, the liquid detergent is applied directly onto the dirty parts of the fabrics, before they are washed in the machine.

Various devices which are suitable for use both as a dispensing device inside a washing machine and as an applicator for pretreatment purposes have been proposed in the art.

For example, WO-95/29122 discloses such a combined applicator and dispenser device, comprising a hollow body made from a flexible material, an opening for filling the hollow body with liquid detergent and at least one cut through the thickness of a portion of the hollow body. Said cut opens progressively when squeezing said device and said cut is substantially closed again when the squeezing stops.

This cut allows for a substantially leakage-free operation of the device. However, on the other hand this device is rather inconvenient and requires the consumer to exercise some degree of control to achieve adequate liquid flow without spillage.

U.S. Pat. No. 5,887,753 discloses a different type of pretreating and dispensing device, having a hollow body and an opening for receiving liquid detergent. This device also includes dispensing means for spreading at least a portion of the liquid detergent onto the fabrics, when used for pretreating. These dispensing means include a roller-ball which is freely rotatable within a cavity, and fabrics can be pretreated by applying the liquid detergent present within the hollow body to said fabrics by the action of the roller-ball rubbing against the fabrics.

It has been observed that leakage of the liquid detergent product is a problem when using this device. U.S. Pat. No. 5,887,753 offers two alternative systems for controlling this leakage.

In one embodiment, similar to the above-outlined system of WO-95/29122 the body of the device is flexible so that a slit covering the roller-ball containing dispensing means can be opened by squeezing. However, as indicated herein above this method is rather inconvenient.

It is also suggested in U.S. Pat. No. 5,887,753 that the hydrostatic pressure exercised against the roller ball by the liquid detergent contained in the device will ensure that the device is leakage-free.

However, we have observed a problem with this method, namely the fact that in addition to providing the force sealing the orifice, the hydrostatic head also acts to force the liquid through any remaining gap. Furthermore, the detergent liquid products typically used are isotropic, Newtonian fluids. These will therefore have the same viscosity under all conditions, specifically at rest and under shear when they are applied to the fabrics during pretreating by rubbing action of the roller-ball. The viscosity of such Newtonian fluids is typically in the range of between 0.1 Pa·s and 1.0 Pa·s, and the hydrostatic head thereof will only be at most 0.02-0.03 metres. This will inevitably lead to films of detergent fluid of substantial thickness and persistence, preventing proper closure of the orifice between the roller-ball containing dispensing means and the detergent liquid containing hollow body, resulting in leakage of liquid product.

Consequently, it is an object of the present invention to provide a dosing and dispensing system adapted to pretreat fabrics, and with which the above outlined problems are effectively overcome.

We have now surprisingly found that this and other objects can be achieved by designing a dosing and dispensing system comprising a non-Newtonian liquid detergent displaying shear-thinning properties.

### DEFINITION OF THE INVENTION

Accordingly, in a first aspect the present invention provides a dosing and dispensing system, comprising a liquid detergent composition and a dosing and dispensing device, wherein the liquid detergent composition is a non-Newtonian fluid having a viscosity profile such that from rest and up to an applied shear stress of 10 Pa the viscosity of the liquid is at least 100 Pa·s, and such that under a shear stress of at least 100 Pa and greater the viscosity is at most 5 Pa·s, and wherein the device comprises
(a) a hollow body having an opening and containing the liquid detergent composition; and
(b) dispensing means to spread at least a portion of the liquid detergent composition onto fabrics, comprising:
   (i) a cavity having a mouth and at least one orifice; and
   (ii) a ball present within said cavity and communicating with said orifice, said ball being freely rotatable in all directions.

In a second aspect, the present invention provides a process for pretreating and washing fabrics in a washing machine using the dosing and dispensing system of the invention, comprising the following steps:
(a) introducing the total quantity of the liquid detergent composition of the invention to be utilized for pretreatment and washing into the dosing and dispensing device;
(b) pretreating the fabrics with a controlled quantity of the liquid detergent composition by rubbing action of the ball; and
(c) placing the thus-pretreated fabrics in the drum of a washing machine together with the dosing and dispensing device and with other non-pretreated fabrics.

### DETAILED DESCRIPTION OF THE INVENTION

The main advantage of the dosing and dispensing system of the present invention is that the operation thereof is safe, leak-free and simple.

Hence, when using said system for pretreating stains on fabrics, wastage of the liquid detergent product used is considerably reduced as compared to known systems of the prior art.

In its broadest scope, the system of the invention comprises a combination of a non-Newtonian liquid detergent composition as specified in claim 1 and a dosing and dispensing device essentially as disclosed by U.S. Pat. No. 5,887,753. Therefore, this US patent document is generally referred to for more background information on the dosing and dispensing device used in the system of the present invention.

The hollow body which generally constitutes the main part of the device, may be made up of any material resistant to water and also to weak acid/alkaline material, usually present in the detergent composition used in the system of the invention. It should also be able to withstand temperatures usually reached in a washing machine, in particular temperatures up to 95° C. The hollow body may also be deformable at least by the mechanical agitation during the wash cycle and resilient to regain its original shape after any deformation.

This characteristic helps wash liquor to enter into the hollow body and, thus, to reduce the formation of any residue.

The dispensing means for spreading at least a portion of the liquid detergent composition of the invention onto fabrics, comprise a cavity having a mouth and at least one orifice. The orifice brings in communication the liquid detergent contained in the hollow body with the ball which—as part of the dispensing means—is present for effectively pretreating the fabrics.

The ball has to have the possibility to rotate freely in all directions when spreading the liquid detergent composition during pretreatment. This is preferably accomplished in the following way. The ball is partly located within the cavity which has two openings: the orifice and the mouth. The ball protrudes at least partially from the mouth. The dimensions of the ball and the dimensions of the mouth are tuned one to each other so that the ball is not able to exit completely through the mouth.

The ball located within the cavity is not bound to act in predetermined directions. This is due to the fact that said ball is able to rotate about any possible axis. This allows a more even spreading of the liquid detergent in all possible directions.

The non-Newtonian detergent liquid composition of the invention is relatively viscous, and has a viscosity from rest up to a shear stress of 10 Pa of at least 100 Pa·s, preferably at least 500 Pa·s, more preferably at least 1000 Pa·s.

On the other hand, the shear-thinning properties of said liquid composition are such that its viscosity under a shear stress of 100 Pa or greater is at most 5 Pa·s, preferably at most 1 Pa·s, more preferably at most 0.5 Pa·s. The shear-thinning behaviour of this liquid composition ensures that leak-free operation of the system of the invention is obtained while at the same time ensuring that an adequate amount of the detergent composition is dispensed onto the fabric in an even and easily controlled manner.

Preferably, the liquid detergent composition of the invention contains suspended therein agglomerates or capsules, desirably having a diameter of from 0.5 to 2 mm. Such agglomerates or capsules are typically added in order to incorporate additional functional ingredients into the liquid detergent composition that may not be compatible with (other constituents of) said liquid composition when in dissolved form. Alternatively, these capsules may be added in order to incorporate ingredients in encapsulated form that would as such deactivate or be deactivated by other ingredients.

When such capsules or agglomerates are present in the liquid detergent composition, it is desirable to apply a dispensing means wherein the freely rotatable ball contains dimples.

For practical reasons, these dimples are preferably uniformly distributed over the outer surface of the rotatable ball. It is also desirable that these dimples have a circular, ovoid or polyhedral cross-section.

Furthermore, in order to obtain good pretreatment performance the size of these dimples is controlled such that they have a depth and surface diameter which are at least twice as large as the diameter of the agglomerates or capsules. On the other hand, it is desirable that the diameter of the dimples is not larger than 0.2 πr wherein r is the radius of the ball. At such a maximum diameter of the dimples, a total of ten dimples can be uniformly distributed around the outer surface of the ball.

Further advantages, features and details of the present invention will be clarified by way of the following description of a preferred embodiment thereof with reference to the annexed drawings, in which:

FIG. 1 shows a dosing and dispensing device according to the invention;

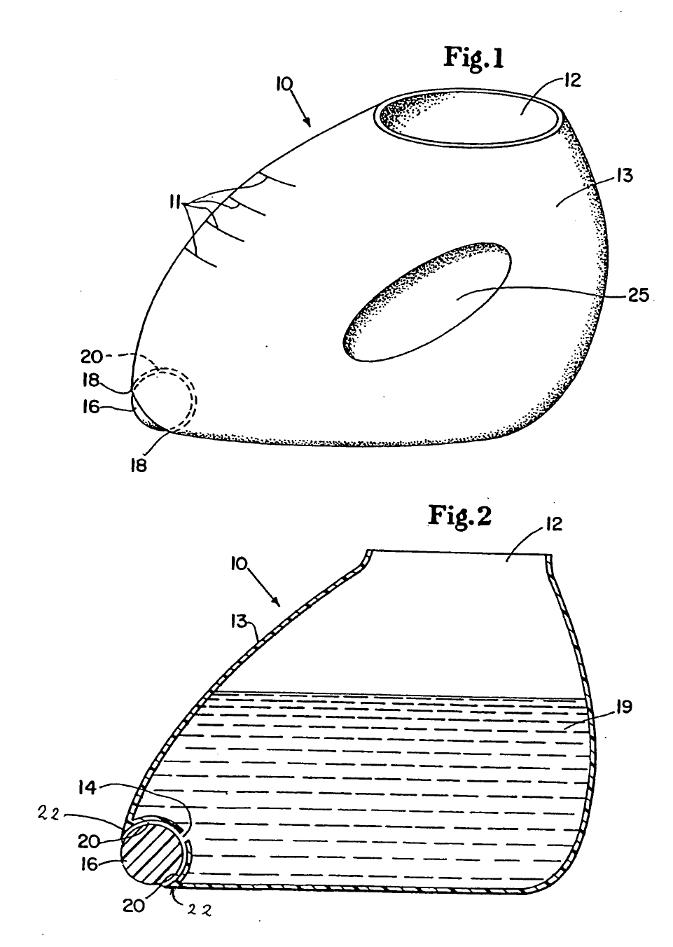

FIG. 2 illustrates a cross-section of said device, and

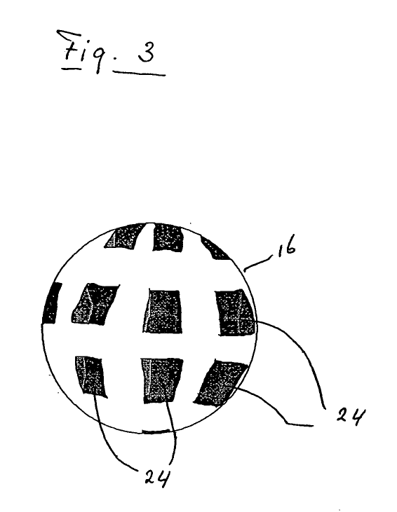

FIG. 3 shows an enlarged view of the rotatable ball located in said device.

As shown in FIGS. 1 and 2, the dosing and dispensing device (10) comprises a hollow body (13), an opening (12), an orifice (14) and a rotatable ball (16). The orifice and the ball are pretreatment means. The hollow body may for example be made of plastic materials, such as polyethylene, polypropylene, polyurethane, or any other similar material.

The device (10) is transparent to allow a visible dosing of the liquid detergent into the device. To facilitate the dosing of the liquid, the device comprises dosing lines (11) located on the external or internal surface of the hollow body. Through the opening (12) the filling of the device with the liquid detergent is achieved. When the device is put inside the washing machine with the fabrics, it also allows the dispensing of the liquid detergent into the wash liquor during the wash cycle.

The orifice (14) brings in communication the detergent liquid (19) contained in the hollow body (13) with the rotatable ball (16). The dimensions and the shape of the orifice are chosen such that favourable operation is achieved.

As schematically shown in FIGS. 1 and 2, the ball (16) is partially located in cavity (20). This cavity (20) has two openings: the mouth (18) and the orifice (14). The ball protrudes at least partly from the mouth (18). The lips (22) hold the ball inside the mouth. The dimensions of the ball and those of the mouth are such that the ball cannot exit completely through the mouth.

As shown in FIG. 3, the rotatable ball (16) contains a large number of dimples (24) which are uniformly distributed on the outer surface of the ball and which allow that detergent liquids containing capsules and/or agglomerates may be applied in the system of the invention for pretreatment purposes. This embodiment is particularly advantageous because in many cases the action of the ingredients present in encapsulated form may be significantly enhanced during the pretreatment washing step.

In the absence of suitable dimples on the surface of the rotating ball, delivery of these ingredients to the surface of the fabric would be precluded.

The liquid tightness of the illustrated device is partly ensured by the hydrostatic pressure of the liquid detergent composition (19) which may typically be due to a head of 0.02-0.03 metres, which pushes the ball (16) towards the lips (22) of the mouth. Liquid tightness of the invention in its broadest form is further improved by the properties of the detergent composition which ensure that only a thin film of liquid remains between the rotating ball and the surrounding portions of the device while at the same time providing for a liquid at rest in the cavity which has a high viscosity and hence a very slow flow rate. In this preferred embodiment, that property is particularly important in that complete closure of the orifice is not possible due to the presence of the dimples on the surface of the rotating ball.

It can further be noticed that the pretreatment means are in the bottom part of the device (10), while the opening (12) being located on the top part of the device. This location of the pretreatment means ensures that the level of the liquid detergent (19) is always above the orifice (14). This means that the liquid detergent does not need to be poured into the cavity through the orifice (14).

Furthermore, the device remains in the same position both during pretreatment and at rest, which allows an easy measuring and controlling of the liquid detergent applied for pretreatment.

Gripping means (25) are also provided in the form of cavities on the external surface of the hollow body (13). They facilitate in holding the device for pretreatment.

It goes without saying that the present invention is not limited to the above described preferred embodiment thereof. The requested rights are primarily defined by the following claims, within the scope of which various modifications are possible.

1. A dosing and dispensing system, comprising a liquid detergent composition and a dosing and dispensing device, wherein the liquid detergent composition is a non-Newtonian fluid having a viscosity profile such that, when in rest or up to an applied shear stress of 10 Pa, the viscosity is at least 100 Pa·s, and such that under a shear stress of at least 100 Pa the viscosity is at most 5 Pa·s, and wherein the device comprises
(a) a hollow body having an opening and containing the liquid detergent composition; and
(b) dispensing means to spread at least a portion of the liquid detergent composition onto fabrics, comprising:
(i) a cavity having a mouth and at least one orifice; and
(ii) a ball present within said cavity and communicating with said orifice, said ball being freely rotatable in all directions.

2. A system according to claim 1, wherein the viscosity of the liquid detergent composition is at least 500 Pa·s, preferably at least 1000 Pa·s, when in rest or under a shear stress of up to 10 Pa.

3. A system according to claim 1, wherein the shear thinning properties of the liquid detergent composition are such that its viscosity under a shear stress of 100 Pa or greater is at most 1 Pa·s.

4. A system according to claim 1, wherein the liquid detergent composition contains suspended therein agglomerates or capsules, having a diameter of from 0.5 to 2 mm.

5. A system according to claim 1, wherein the diameter of said mouth is at least slightly smaller than the diameter of said ball, and said ball protrudes partly outside of said mouth.

6. A system according to claim 1, wherein said ball contains dimples uniformly distributed over the outer surface thereof.

7. A system according to claim 6, wherein said dimples have a circular, ovoid or polyhedral cross-section.

8. A system according to claim 6, wherein the size of the dimples is controlled such that they have a depth and surface diameter which are at least twice as large as the diameter of the agglomerates or capsules.

9. A system according to claim 6, wherein the surface diameter of the dimples is no greater than 0.2πr, wherein r is the radius of the ball.

10. Process for pretreating and washing fabrics in a washing machine with the dosing and dispensing system according to claim 1, said process comprising the following steps:
(a) introducing the total quantity of a liquid detergent composition to be used for pretreatment and washing into the dosing and dispensing device;
(b) pretreating the fabrics with a controlled quantity of the liquid detergent composition by rubbing action of the ball; and
(c) placing the thus-pretreated fabrics in the drum of a washing machine together with the dosing and dispensing device and with other non-pretreated fabrics.
